(19) United States
(12) Patent Application Publication
(10) Pub. No.: US 2026/0184412 A1
(43) Pub. Date: Jul. 2, 2026

(54) Multifunctional Underwater Electric Auxiliary Equipment

(71) Applicant: Xiayuan Wu, Dongguan (CN)

(72) Inventors: Xiayuan Wu, Dongguan (CN); Maoyong Xie, Huazhou (CN)

(21) Appl. No.: 19/068,293

(22) Filed: Mar. 3, 2025

(30) Foreign Application Priority Data
Dec. 26, 2024 (CN) 2024119335316

(51) Int. Cl. B63H 23/06; B63C 11/46; F16H 1/04

(52) U.S. Cl. CPC B63H 23/06; B63C 11/46; F16H 1/04

(57) ABSTRACT

The invention relates to the technical field of underwater electric equipment, in particular to a multifunctional underwater electric auxiliary equipment comprising power device (100) and any first load device (200) and second load device (300) detachably connected with power device (100), first load device (200) has a first load end (201) having a first accommodating cavity (2011) adapted to the power output gear (101), and second load device (300) has a second load end (301) having a second accommodating cavity (3011) adapted to power output gear (101). Power device of this invention can be quickly assembled or disassembled with either first load device or second load device, thereby reducing maintenance time and costs. Consequently, power device can be assembled with either first load device or second load device, offering rich functionality at a low cost.

### TECHNICAL FIELD

The invention relates to the technical field of underwater electric equipment, in particular to a multifunctional underwater electric auxiliary equipment.

### BACKGROUND OF THE PRESENT INVENTION

There are many kinds of underwater electric equipment, and they are widely used in different industries and fields, such as ocean exploration, aquaculture, scientific research, underwater engineering, recreational sports, etc. Examples include underwater thrusters, underwater camera equipment, underwater robots, underwater cleaning equipment, etc.

The Chinese utility model patent with announcement number CN216783823U discloses an underwater thruster, which comprises a sealed cabin, a motor and a propelling paddle, wherein the motor is arranged in the sealed cabin, and an output shaft of the motor is connected with the propelling paddle, and the propelling paddle is located in the flow guide cover.

The Chinese utility model patent with announcement number CN210768005U discloses an underwater sewage suction machine, which comprises a power device, a filter device, the power device comprising a suction assembly and a power drive device providing power to the suction assembly, the power output shaft of the power drive device is connected with the suction assembly through a flexible shaft, the suction assembly is arranged as a centrifugal impeller, and the power drive device is arranged as a motor.

The power part and the load part of the aforementioned two kinds of underwater electric equipment are rigidly connected and cannot be separated. When the equipment fails or needs maintenance, it is not easy to disassemble and assemble, repair and maintenance become more complicated, and the functions are relatively single, and it is impossible to expand multiple functions. There is no interchangeability between components, and the cost is high, which cannot meet the modern people's demand for multifunctional use and optimal utilization of underwater electric equipment.

Therefore, the existing technology needs to be improved and enhanced.

### SUMMARY OF PRESENT INVENTION

In order to overcome the above problems in the prior art, the object of the invention is to provide a multifunctional underwater electric auxiliary device that is easy to assemble and disassemble, multifunctional, convenient to interchange, and low-cost.

The invention achieves the above object by the following technical means:

A multifunctional underwater electric auxiliary device includes power device and either first load device or second load device that can be detachably connected to power device. Power device has power output gear. First load device has first load end, and first load end has first accommodating chamber that is adapted to power output gear. Second load device has second load end, and second load end has second accommodating chamber that is adapted to power output gear. Power output gear includes gear body with mounting hole located in the middle. Gear body has teeth distributed on its circumferential outer edge, with the number of teeth ranging from 3 to 10. Second load end is axially provided with an even number of elastic buckles that match the power output gear on its end facing the power output gear.

As a further aspect of the invention, the number of teeth is six.

As a further aspect of the invention, the end of teeth facing the first load device or second load device is designed in a curved guide engagement.

As a further aspect of the invention, first teeth are distributed on the circumferential inner wall of first accommodating cavity, and second teeth are distributed on the circumferential inner wall of second accommodating cavity.

As a further aspect of the present invention, the end of first tooth facing power output gear is of a curved surface guide engagement design.

As a further aspect of the present invention, tooth slots adapted to first teeth or second teeth is formed between two adjacent teeth, and first tooth slots adapted to teeth is formed between two adjacent first teeth, second tooth slots adapted to teeth is formed between two adjacent second teeth.

As a further aspect of the invention, two elastic buckles correspond to two second tooth slots.

As a further aspect of the present invention, elastic buckle comprises a buckle body and an inverted buckle projection arranged on the inner side of the free end of buckle body.

As a further aspect of the invention, the free end of the buckle body is inclined inwardly.

According to a further aspect of the present invention, undercut protrusion has an inclined surface on the side facing power output gear and a curved surface on the side away from power output gear.

Compared with the prior art, the invention has the following advantages:

By adopting the above structural design, that is, by arranging power device and any first load device and second load device detachably connected with power device, power output gear of power device is adapted to first accommodating cavity of first load end of first load device or power output gear of power device is adapted to second accommodating cavity of second load end of second load device, wherein gear body of power output gear is distributed with 3-10 teeth on the circumferential outer circle; The end of second load end facing power output gear is oppositely arranged with two elastic buckles matched with power output gear along the axial direction, no screws or nuts required for secondary fixation; Combined with the above, power device and first load device or second load device can be quickly disassembled and assembled, the functions can be quickly switched, and the maintenance time and cost can be reduced, so that power device can be assembled with either first load device or second load device, offering rich functionality at a low cost.

### BRIEF DESCRIPTION OF THE DRAWINGS.

FIG. 1 is a schematic diagram of an assembly of power device and first load device according to an embodiment of the present invention;

FIG. 2 is another schematic diagram of an embodiment of the present invention when power device and first load device are assembled;

FIG. 3 is a schematic diagram of an embodiment of the present invention when power output gear is assembled with first load end;

FIG. 4 is a schematic structural diagram of power output gear according to an embodiment of the present invention;

FIG. 5 is a schematic structural diagram of first load end according to an embodiment of the present invention;

FIG. 6 is a schematic diagram of an assembly of power device and second load device according to an embodiment of the present invention;

FIG. 7 is another schematic diagram of the assembly of power device and second load device according to the embodiment of the present invention;

FIG. 8 is a schematic structural diagram of second load end according to an embodiment of the present invention;

FIG. 9 is a schematic diagram of assembling second load end and power output gear according to an embodiment of the present invention;

Each label in the figure is:
100—power device, 200—first load device, 300—second load device;
101—power output gear;
201—first load end;
301—second load end;
2011—first accommodating cavity, 2012—first tooth, 2013—first tooth slot;
3011—second accommodating cavity, 3012—elastic buckle, 3013—second tooth, 3014—second tooth slot;
1011—gear body, 1012—mounting hole, 1013—tooth, 1014—tooth slot, 1015—curved surface;
3012a—buckle body, 3012b—undercut protrusion.

### DETAILED DESCRIPTION OF THE EMBODIMENT'S

With reference to the drawings in the embodiments of the present application, the following provides a clear and complete description of the technical solutions in the embodiments of the present application. Obviously, the described embodiment is merely part of the embodiments of the present application and not all of them. Based on the embodiments in the present application, all other embodiments obtained by those skilled in the art without creative work fall within the scope of protection of the present application.

In the description of the present application, it should be understood that the orientation or positional relationship indicated by the terms “center”, “upper”, “lower”, “front”, “back”, “left”, “right”, “vertical”, “horizontal”, “top”, “bottom”, “inner”, “outer”, etc. is based on the orientation or positional relationship shown in the drawings, and is merely for convenience and simplification of the description of the present application, and does not indicate or imply that the referred device or element must have a specific orientation, be constructed and operated in a specific orientation, and therefore cannot be construed as a limitation of the present application.

The terms “first” and “second” are for descriptive purposes only and are not to be understood as indicating or implying relative importance or as implicitly indicating the number of technical features indicated. Thus, a feature defined as “first” or “second” may explicitly or implicitly include one or more of the features. In the description of the present application, unless otherwise specified, “a plurality” means two or more.

In the description of the present application, it should be noted that unless otherwise explicitly specified and limited, the terms “mounted”, “connected” and “linkage” should be understood in a broad sense, for example, they may be fixed connected, detachable connected, or integrally connected; It can be a mechanical connection, a direct connection, an indirect connection through an intermediate medium, or an internal connection between two elements. Those of ordinary skill in the art can understand the specific meanings of the above-mentioned terms in the present application.

### Embodiment

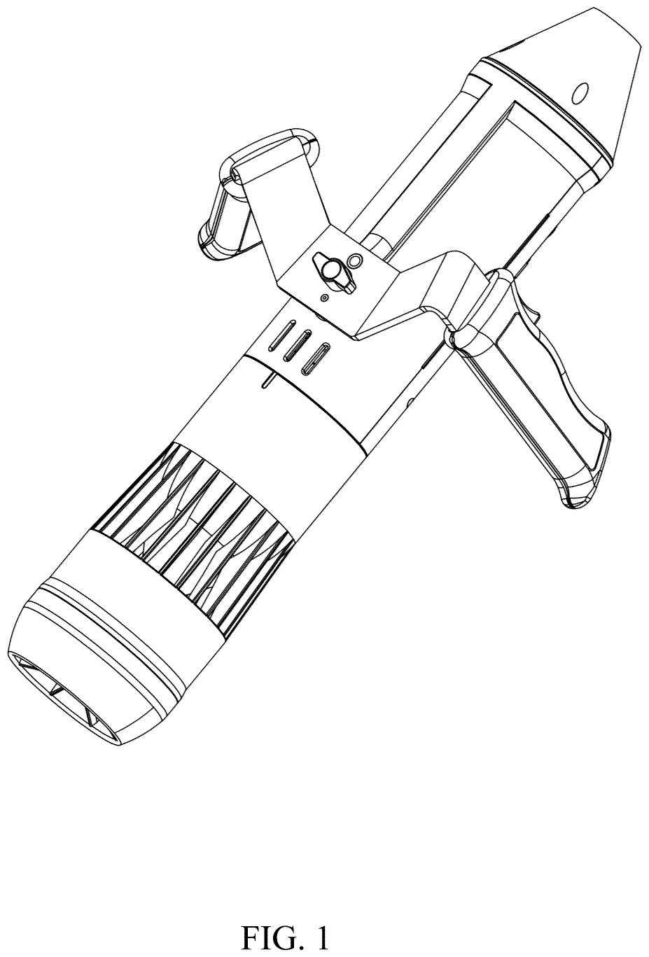

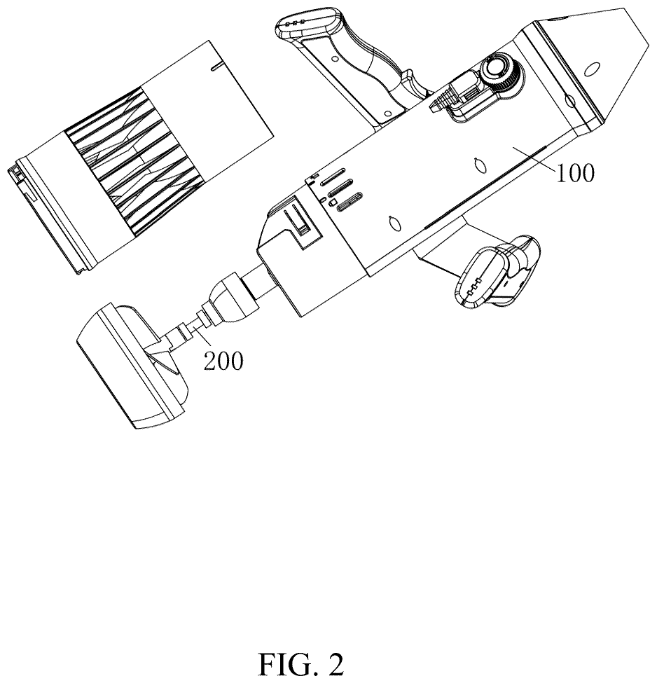

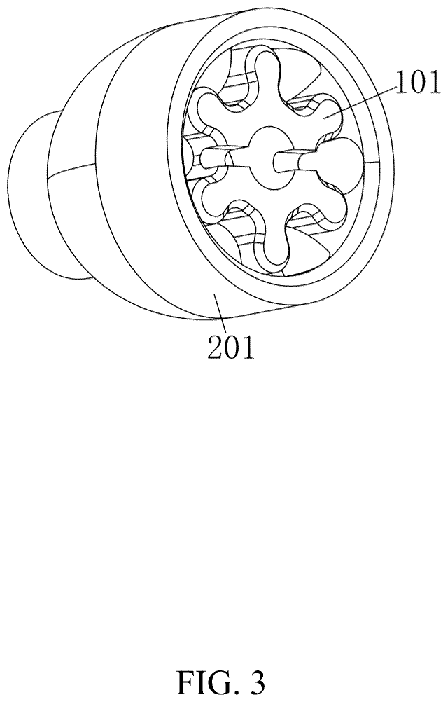

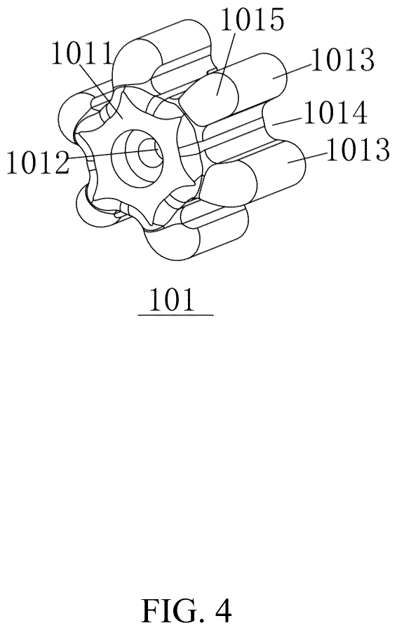

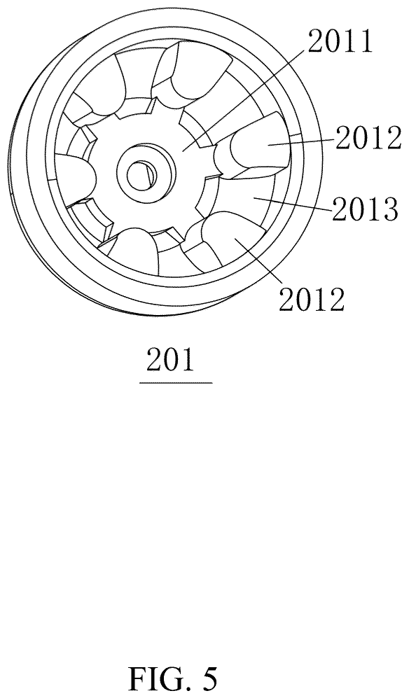

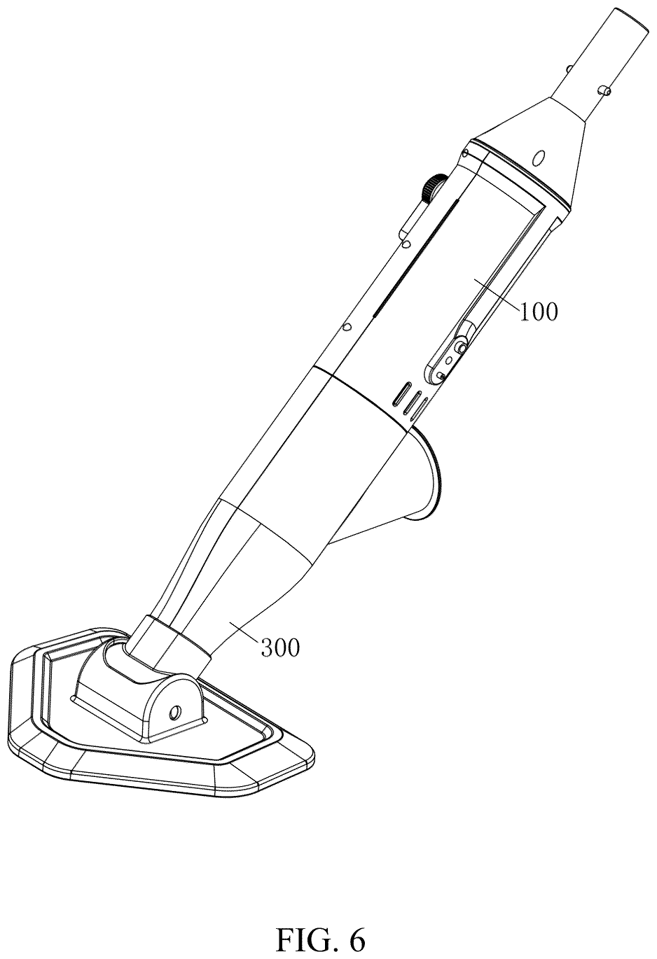

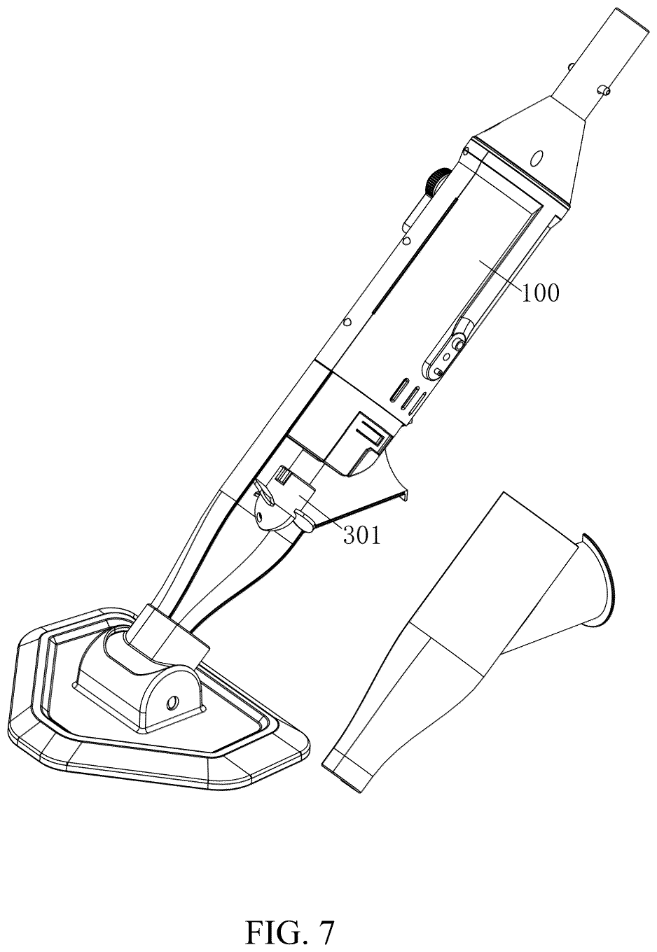

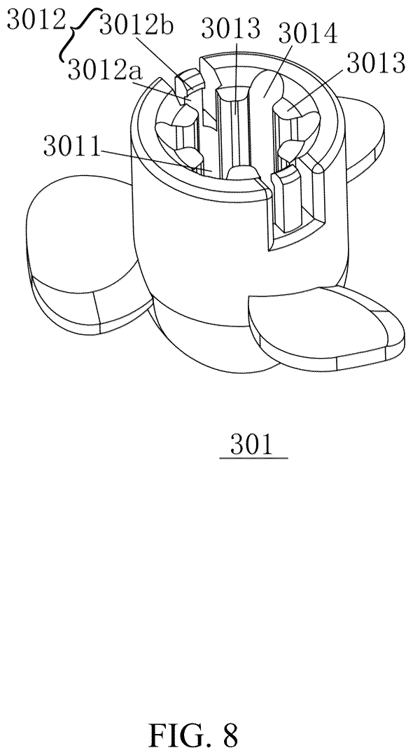

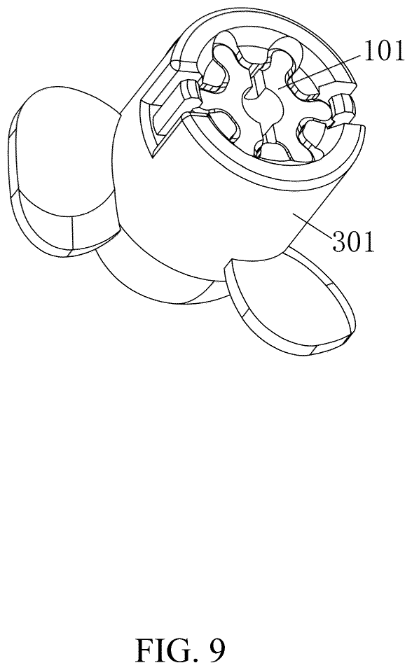

As shown in FIGS. 1-9, the present application provides a multifunctional underwater electric auxiliary device, comprising power device 100 and any first load device 200 and second load device 300 detachably connected to power device 100. In this embodiment, power device 100 uses an electric motor, first load device 200 is a propeller blade assembly, and second load device 300 is a suction assembly. Power device 100 and first load device 200 are assembled to form an underwater propeller, and power device 100 and second load device 300 are assembled to form an underwater suction machine.

Specifically, when power device 100 and first load device 200 are assembled into the underwater thruster, when power device 100 starts the motor, the output shaft of the motor is installed with power output gear 101, power output gear 101 includes gear body 1011, mounting hole 1012 is provided at the middle position of gear body 1011, and gear body 1011 is distributed on the circumferential outer circle. Teeth 1013 are distributed around the outer circumference of the gear body 1011. According to actual application needs, the number of teeth 1013 can be set between 3 and 10 to meet different product requirements. In this embodiment, the number of teeth 1013 is six. The teeth 1013 has a curved surface guide engagement design at the end facing first load device 200, i.e., the end of teeth 1013 facing first load device 200 is a curved surface 1015.

First load device 200 is a propeller blade assembly, which includes first load end 201, housing, etc. First load end 201 has first accommodating cavity 2011 that is adapted to power output gear 101. Through the aforementioned structural design, during installation, power output gear 101 can be inserted into first load end 201 without restriction on the angle, as both power output gear 101 and the corresponding first load end 201 have curved surface guide engagement designs at their ends. Power output gear 101 has a relatively large rotational resistance and is relatively fixed, while first load end 201 connected to the propeller has no rotational resistance and can freely rotate. When the curved surface end of power output gear 101 contacts the curved surface end of first load end 201, the tangent surfaces cause first load end 201 to rotate, allowing power output gear 101 to smoothly insert into first accommodating cavity 2011 of first load end 201. This enables quick assembly and disassembly of power device and first load end, reducing maintenance time and costs. Even in the case of a blind spot, i.e., in non-visible conditions, the gear connection can still be carried out, greatly improving installation speed and efficiency.

Normally, in this embodiment, the propeller blades of the propeller blade assembly are mounted inside the housing of the propeller blade assembly near the tail end of the housing, which also places first load end 201 near the tail end of the housing. Meanwhile, the length of the motor's output shaft is fixed. If the traditional rigid connection technique of the motor shaft and the propeller blade is adopted, the assembly and disassembly would be quite troublesome and complex. However, with the present application, power output gear 101 only needs to be inserted into the housing of the propeller blade assembly. By means of blind insertion, power output gear 101 can be easily inserted into first load end 201. Finally, by rotating the housing of first load device 200 and buckle structure on power device, the assembly of power device 100 and first load device 200 is achieved.

Specifically, when power device 100 and second load device 300 form an underwater sewage suction machine, second load device 300 is a sewage suction assembly, and the sewage suction assembly includes second load end 301, and second load end 301 has second accommodating cavity 3011 adapted to power output gear 101; The end of second load end 301 facing power output gear is oppositely provided with an even number of elastic buckles 3012 matched with power output gear along the axial direction, in this embodiment, there are two elastic buckles 3012, through the above structural design, when installing, only second load end 301 corresponds to power output gear 101, and elastic buckles 3012 are locked on teeth 1013 of power output gear 101, so that second load end 301 is installed on power output gear 101; During disassembly, an external force is applied to overcome the friction force between elastic buckle and teeth of power output gear, so that second load device 300 is disengaged from power output gear 101 on the output shaft of power device, thereby realizing rapid disassembly and assembly of the present application and power device, and reducing maintenance time and cost. In this embodiment, second load end 301 includes a blade body and three blades distributed on the circumferential outer circle of the blade body, and the end of the blade body facing transmission is oppositely provided with two elastic buckles 3012 matched with the power output gear along the axial direction.

In this embodiment, second load end 301 is independent of second load device 300, and is first installed on power device 100. During installation, power output gear 101 is inserted into second accommodating cavity 3011 of second load end 301, and since the elastic buckle 3012 corresponds to teeth 1013 of power output gear 101, elastic buckle 3012 is locked on the teeth of power output gear, and finally other components of second load device 300 are installed to complete the final installation.

Specifically, tooth slot 1014 adapted to first tooth 2012 is formed between two adjacent teeth 1013, and first teeth 2012 are distributed on the circumferential inner wall of the first accommodating cavity 2011. First tooth slot 2013 adapted to teeth 1013 is formed between two adjacent first teeth 2012. Through the cooperation of teeth 1013 with first tooth slot 2013 and first teeth 2012 with tooth slot 1014, power output gear 101 and first load end 201 can be well assembled together. Similarly, second teeth 3013 are distributed on the circumferential inner wall of the second accommodating cavity 3011. Second tooth slot 3014 adapted to the teeth 1013 is formed between two adjacent second teeth 3013. Through the cooperation of teeth 1013 with the second tooth slot 3014 and second teeth 3013 with tooth slot 1014, power output gear 101 and second load end 301 can be well assembled together.

Specifically, the two elastic buckles 3012 correspond to two second tooth slots 3014. Through the aforementioned structural design, teeth 1013 engage with second tooth slots 3014, while elastic buckles 3012 correspond to teeth 1013, making elastic buckles 3012 latch onto the teeth 1013. This ensures a stable connection between second load end 301 and power device 100.

Specifically, the propeller body is provided with a notch corresponding to second tooth slot 3014, and the bottom of the notch is provided with elastic buckle 3012. The elastic buckle 3012 includes buckle body 3012a and an undercut protrusion 3012b arranged on the inner side of the free end of buckle body 3012a.

As a preferred embodiment of this example, the free end of buckle body 3012a inclines inwardly. When power output gear 101 is inserted into second accommodating cavity 3011, the inwardly inclined free end can easily latch onto teeth 1013 of power output gear 101.

As a preferred mode of the present embodiment, the side of the undercut protrusion 3012b facing the power output gear 101 is an inclined surface, which is convenient for the power output gear 101 to be inserted into the second accommodating cavity 3011, and the side away from the power output gear 101 is an arc surface, which is convenient for applying an external force to disengage the power output gear 101 from the second load end 301.

In summary, teeth 1013 have a curved surface guide engagement design at the ends facing first load device 200 or second load device 300. First teeth 2012 also have a curved surface guide engagement design at the ends facing power output gear 101. Through the aforementioned structural design, the blind insertion operation of power output gear and first load end becomes easier and simpler due to the curved surface guide engagement design of both the ends of teeth 1013 and first teeth 2012. The assembly of power output gear 101 and second load end 301 only requires direct insertion. Consequently, power device can easily switch load devices, enabling easy assembly with either first load device or second load device. As only one generalized power device is required to achieve two different functions, the purpose of achieving rich functionality and low cost is realized. Of course, other underwater electric devices can also be modified according to the structure of this application to share the same power device and achieve multiple functions.

Through the aforementioned structural design, the present invention addresses the shortcomings of prior art, featuring a rational structure, low cost, and strong practicality.

In the description of this specification, specific features, structures, materials, or characteristics can be combined in any suitable manner in one or more embodiments or examples.

The above descriptions are merely specific embodiments of this application. However, the scope of protection of this application is not limited thereto. Any modifications or substitutions easily conceived by those skilled in the art within the disclosed technical scope of this application should also fall within the scope of protection of this application. Therefore, the scope of protection of this application shall be subject to the scope of the claims. In addition, specific examples are provided in the specification to explain the principles and implementations of this application. The descriptions of the above embodiments are merely to help understand the methods and core ideas of this application. The content of this specification should not be understood as limiting this application.

1. A multifunctional underwater electric auxiliary device is characterized in that it includes power device (100) and either first load device (200) or second load device (300) that can be detachably connected to power device (100); power device (100) has power output gear (101); first load device (200) has first load end (201), and first load end (201) has first accommodating chamber (2011) that is adapted to power output gear (101); second load device (300) has second load end (301), and second load end (301) has second accommodating chamber (3011) that is adapted to power output gear (101); power output gear (101) includes gear body (1011) with mounting hole (1012) located in the middle; gear body (1011) has teeth (1013) distributed on its circumferential outer edge, with the number of teeth (1013) ranging from 3 to 10; second load end (301) is axially provided with an even number of elastic buckles (3012) that match the power output gear (101) on its end facing the power output gear (101).

2. The multifunctional underwater electric auxiliary device according to claim 1, is characterized in that the number of teeth (1013) is six.

3. The multifunctional underwater electric auxiliary device according to claim 2, is characterized in that the ends of teeth (1013) facing first load device (200) or second load device (300) are of a curved surface guide engagement design.

4. The multifunctional underwater electric auxiliary device according to claim 3, is characterized in that first teeth (2012) are distributed on the circumferential inner wall of first accommodating cavity (2011), and second teeth (3013) are distributed on the circumferential inner wall of second accommodating cavity (3011).

5. The multifunctional underwater electric auxiliary device according to claim 4, is characterized in that the end portion of first teeth (2012) facing power output gear (101) have a curved surface guide meshing design.

6. The multifunctional underwater electric auxiliary device according to claim 5, is characterized in that tooth slots (1014) adapted to first tooth (2012) or second teeth (3013) is formed between two adjacent teeth (1013), and first tooth slots (2013) adapted to teeth (1013) is formed between two adjacent first teeth (2012), second tooth slots (3014) adapted to teeth (1013) is formed between two adjacent second teeth (3013).

7. The multifunctional underwater electric auxiliary device according to claim 6, is characterized in that two elastic buckles (3012) correspond to two second tooth slots (3014).

8. The multifunctional underwater electric auxiliary device according to claim 7, is characterized in that elastic buckle (3012) includes buckle body (3012a) and undercut protrusion (3012b) arranged on the inner side of the free end of the buckle body (3012a).

9. The multifunctional underwater electric auxiliary device according to claim 8, is characterized in that the free end of buckle body (3012a) is inclined inwardly to form an undercut.

10. The multifunctional underwater electric auxiliary device according to claim 9, is characterized in that undercut protrusion (3012b) has an inclined surface on the side facing power output gear (101) and a curved surface on the side away from power output gear (101).
